(19) United States
(12) Patent Application Publication
(10) Pub. No.: US 2024/0222972 A1
(43) Pub. Date: Jul. 4, 2024

(54) AN INVERTER SYSTEM FOR ACTIVE HARMONIC FILTER AND STATIC COMPENSATOR APPLICATIONS

(71) Applicant: Elektra Elektronik Sanayi Ve Ticaret Anonim Sirketi, Istanbul (TR)

(72) Inventor: Veysel Tutku Büyükdegirmenci, Istanbul (TR)

(21) Appl. No.: 17/800,699

(22) PCT Filed: Dec. 31, 2021
(86) PCT No.: PCT/TR2021/051678

§ 371 Date: Apr. 13, 2023

(30) Foreign Application Priority Data
Oct. 4, 2021 (TR) 2021/015443

(51) Int. Cl. H02J 3/01; H02J 3/18; H02M 1/12; H02M 7/5395; H02M 7/493

(52) U.S. Cl. CPC H02J 3/01; H02J 3/1835; H02M 1/12; H02M 7/5395; H02M 7/493

(57) ABSTRACT

The invention relates to a power electronic inverter system (100) which allows to balance the power drawn from the phases, to compensate the reactive power and to filter the harmonics in facilities or plants with unbalanced or single-phase loads.

### TECHNICAL FIELD

The invention relates to a power electronic inverter system which allows to balance the power drawn from the phases, to compensate the reactive power and to filter the harmonics in facilities or plants with unbalanced or single-phase loads.

### PRIOR ART

Today, in plants that are under the inductive influence, in order to help to balance the system by generating a capacitive load to eliminate or balance the inductive energy, the reactive power compensation is realized by using conventional stepped capacitor and shunt reactor compensation systems and a power factor controller that activates and deactivates them. The reactive power factor controller of such structure measures the reactive power and the active power drawn by the facility with the help of current transformers and activates or deactivates the capacitor and/or reactor stages which are necessary to compensate the reactive power.

Generally used static and constant mechanically switched capacitor groups are used to increase the power quality in the transmission and distribution systems. In recent years, some devices for improving the power quality have been developed for the reactive power compensation in the power systems. Recently, IGBT inverter-based static compensators have been released. These systems eliminate the logic of the classic gradual compensation, allowing the plant to operate continuously in a way that it draws net zero reactive power by providing exactly the necessary amount of the reactive power on the network. Similarly, if the plant has a surplus of reactive power, it takes the excess reactive power on itself in order to eliminate it before it goes to the network, ensuring that the net reactive power going to the network is zero. In this way, the power factors of the facilities are kept above 0.99 so that they are protected from penal conditions.

On the other hand, in facilities with nonlinear loads, current harmonics generated cause voltage harmonics to occur. The current harmonics generated cause the chronic failure of the electronic devices used in the facilities, the resonance in the facilities, the explosion of the compensation capacitors and the loss of workforce by not operating at full capacity.

Today, there are two ways to avoid damage caused by voltage harmonics. First of these is the use of the passive harmonic filter (PHF). Passive harmonic filters consist of reactor and capacitor units with a resonance frequency tuned to the harmonic frequency to be filtered. In applications where loads are continuous and constant, it can be ensured that the harmonic levels fall below the limits determined by the standards (IEEE 519). However, in applications where loads are variable and dynamic, PHFs are insufficient to reduce harmonics below the limits determined by the standards. On the other hand, the reactors which are connected to the inputs of the devices to be protected from the voltage harmonics are also included in the PHF class. These reactors show high impedance at harmonic frequencies and limit the harmonic currents. However, in such applications, due to the voltage drop on the reactor, the input voltages of devices drop and they may become inoperable. On the other hand, these reactors may deform the grid voltage waveform and the devices would be more exposed to disruptive effects instead of protecting them.

Systems with an IGBT (different semiconductor switching element—MOSFET etc. can be used) based inverter structure called Active Harmonic Filter are used in facilities with dynamic and constantly changing loads. Thanks to the embedded system structure and high-bandwidth control algorithms, it generates current harmonics in the opposite phase to the current harmonics produced in the facilities and provides them to the grid and eliminates the current harmonics based on the principle of the opposite-phase components canceling each other out. Active harmonic filters, on the other hand, prevent the voltage imbalances and other power quality problems caused by the load imbalances by ensuring that the same current and power is drawn from all phases by performing load balancing in the facilities with unbalanced loads.

Today, there are three-phase static compensator and active harmonic filter products to be applied to three-phase networks. These products have the same current and power capacity for all three phases. In case of unbalanced distribution of harmonics and reactive power in the phases in a facility, static compensators and active harmonic filters are sized according to the phase with the highest power or current need. For this reason, unnecessarily large products are used and unnecessary high-cost installations are required.

Commercially available products have a two-level or three-level inverter topology. In the two-level topology, the switching elements have to switch the entire DC bus voltage, while in the three-level inverters, half of the DC bus voltage is switched. In this way, another output level is obtained and it is possible to operate at higher switching frequencies since the losses are reduced. Since the bandwidth and dynamic speed of the inverter are important in the active harmonic filter applications, it has become necessary to use three or more level inverter structures in order to increase the switching frequency as much as possible. However, since the active harmonic filter and static compensator products available in the market are three-phase, they cannot offer flexible solutions in the applications in which there is a need only in one or two phases, and they remain high cost.

Thus, a method and a system operating according to said method should be developed, which minimize or eliminate the above-mentioned disadvantages in the state of the art.

### BRIEF DESCRIPTION OF THE INVENTION

The object of the invention is to create a solution which is cost-effective and easy-to-install, by connecting all three-phase outputs of a three-phase active harmonic filter or static compensator to a single phase or two-phase, depending on the need, by performing harmonic filtering, load balancing or reactive power compensation only in the required phases.

The invention provides a flexible modular inverter unit with two or more levels, each phase of which can be controlled separately. Said system can perform filtering or compensation operations only in the required phases by connecting all three-phase outputs to a single phase or two-phase, depending on the need.

### DESCRIPTION OF FIGURES

FIG. 1 is a representative view of a block diagram of the system of the invention.

FIG. 2 is the three-phase connection of the system of the invention to the three-phase network.

FIG. 3 is the two-phase connection of the system of the invention to the three-phase network.

FIG. 4 is the single phase connection of the system of the invention to the three-phase network.

FIG. 5 is the representative view of the block diagram of the embedded control system of the invention.

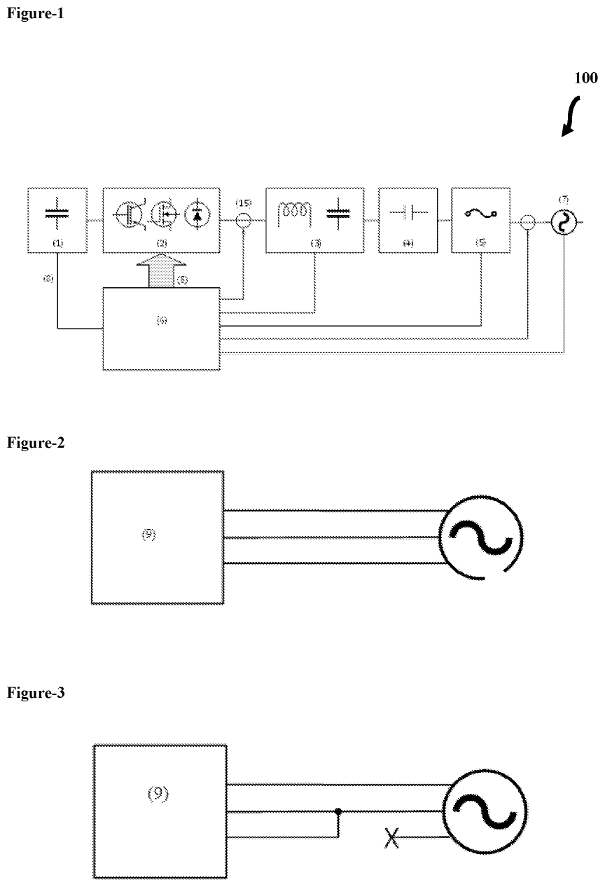

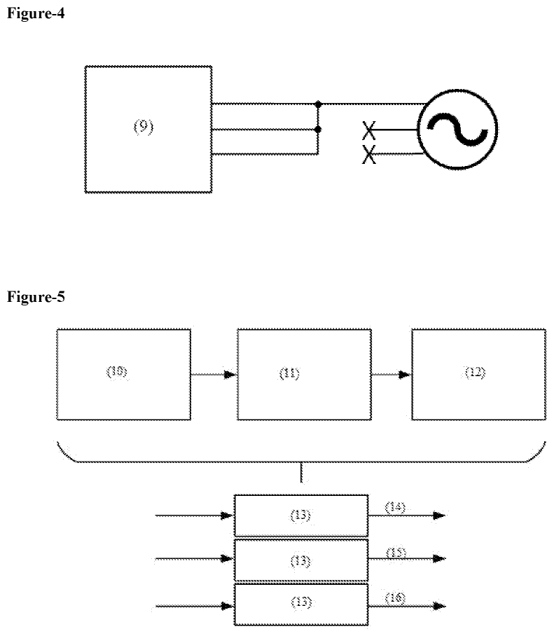

### DESCRIPTION OF THE REFERENCES IN THE FIGURES

The numbers in the drawings are provided below in order to provide a better understanding of the invention:
100. Inverter-based system
   1. DC Bus capacitors
   2. Inverter unit
   3. L, LC or LCL filter topologies
   4. Contactor or relay assembly
   5. Fuse or other protective circuits
   6. Embedded control system
   7. Grid
   8. PWM signals
   9. Three-phase active harmonic filter or static compensator
   10. Analog to digital converter
   11. Calculation unit
   12. PWM modulator
   13. Signal processing unit
   14. PWM signals of phase A
   15. PWM signals of phase B
   16. PWM signals of phase C

### DETAILED DESCRIPTION OF THE INVENTION

In order to provide a cost-effective and easy-to-install solution which balances and/or compensates reactive power and eliminates the negative effects of the current harmonics in facilities and voltage harmonics arising from the current harmonics; the invention comprises at least one inverter unit (2) based on a semiconductor switching elements of at least two levels, at least one cooler and/or at least one fan and/or at least one wind tunnel assembly for cooling the semiconductor elements in the inverter unit (2), at least one passive filter (3) for connecting the inverter unit to the grid (7), DC bus unit (1) to which each phase from the inverter unit is connected commonly, at least one embedded control system (6) which generates the pulse width modulation (PWM) signals by synthesizing the measurements received from the grid (7) into the required compensation and/or filtering current and at least one pre-charge resistor which allows charging the DC bus unit (1) of the inverter unit (2).

Said invention, comprises a DC bus unit (1) in which each active harmonic filter and/or each static compensator (9) is integrated separately and independently. Thanks to the invention, a single DC bus unit (1) can be used instead of using a separate DC bus unit (1), since the phase outputs can be flexibly connected to the desired phase up to the desired power (for example; 3-0-0, 2-1-0, 1-1-1). Thus, it is possible to use smaller products which are cost-effective.

Since said inverter system (2) has a modular structure, as many products as desired can be connected in parallel and in different phase configurations, and in this way, the desired asymmetrical current or power dimensioning becomes possible when necessary.

Said invention operates with the method steps given below.
The controller detects that the product is connected to single phase, two phases or three phases, and generates interleaved carrier signals according to the connection status
The symmetrical triangular wave carrier signals take the current and voltage measurements of the controller at zero and peak moments and convert them to digital media
The control unit carries out the necessary calculations and operations and generates the pulse width modulation (PWM) signals and applies them to the inverter unit
The control unit reduces the need for filtering at the output of the inverter thanks to the fact that it produces interleaved carrier signals It comprises the method steps given above.

The steps of another operating method of the present invention are given below.
Inverter-based system (100), which includes at least 3 phases and at least one neutral connection point, makes asymmetrical two-phase operation by connecting two of the phase outputs to one phase and the other one to another phase
Inverter-based system (100), which includes at least 3 phases and at least one neutral connection point, makes single-phase operation by connecting all three phase outputs to the same phase
The control unit takes the current and voltage measurements and converts them to digital, and generates PWM by making the necessary calculations
The controller unit reduces the need for filtering necessary at the output by using interleaved carrier signals

It comprises the method steps given above.

### INDUSTRIAL APPLICABILITY OF THE INVENTION

The system of the invention is industrially applicable to be used in eliminating the reactive power demand or excess of the plant, cleaning the current harmonics and indirectly voltage harmonics, thanks to the compensation of all the reactive power drawn from the phases, the prevention of the harmonic generating loads from creating disruptive effects on the other loads in the facility, the prevention of the formation of the voltage harmonics indirectly by the current harmonics and the filtering and load balancing for eliminating the negative effects of the voltage imbalances created by the unbalanced loads on different phases, in facilities or plants with unbalanced or single-phase loads.

The invention is not limited to the foregoing exemplary embodiments, and one person skilled in the art may easily reveal the different embodiments of the invention. These should be considered within the scope of protection of the invention claimed in the claims.

1. An inverter-based system (100), characterized in that in order to provide a cost-effective and easy-to-install solution which eliminates the negative effects of the current harmonics, compensates for the reactive power and balances the power drawn from the phases; it comprises at least one inverter unit (2) based on a semiconductor switching element of at least two levels, at least one cooler and/or at least one fan and/or at least one air tunnel assembly for cooling the semiconductor elements in the inverter unit (2), at least one passive filter (3) for connecting the inverter unit (2) to the grid (7), DC bus unit (1) to which each phase from the inverter unit (2) is connected commonly, at least one embedded control system (6) which generates PWM signals by the required compensation of the measurements received from the grid (7) and/or by the synthesis of the filtering current and at least one pre-charge resistor which allows charging the DC bus unit (1) of the inverter unit (2).

2. An inverter based system (100) according to claim 1, characterized in that it comprises a DC bus unit (1) in which each active harmonic filter and/or each static compensator (9) is integrated separately and independently.

3. An inverter based system (100) according to claim 2, characterized in that it comprises a single DC bus unit (1) or a separate DC bus unit (1) can be used since the phase outputs in the product can be flexibly connected to the desired phase up to the desired power.

4. An inverter based system (100) according to claim 3, characterized in that it can be realized by a topology of at least two levels that allows to increase the effective switching frequency and to reduce the size of the passive filter which is necessary for the network connection.

5. A method, characterized by the following steps in order to provide a cost-effective and easy-to-install solution which eliminates the negative effects of the current harmonics and balances reactive power;
The controller detects when the product is connected to single phase, two phases or three phases, and generates interleaved carrier signals according to the connection status
The symmetrical triangular wave carrier signals take the current and voltage measurements of the controller at zero and peak moments and convert them to digital
The control unit carries out the necessary calculations and operations and generates the pulse width modulation (PWM) signals and applies them to the inverter unit (2)
The control unit reduces the need for filtering at the output of the inverter thanks to the fact that it produces interleaved carrier signals.

6. A method, characterized by the following steps in order to provide a cost-effective and easy-to-install solution which eliminates the negative effects of the current harmonics and balances reactive power;
Inverter-based system (100), which includes at least 3 phases and at least one neutral connection point, makes asymmetrical two-phase operation by connecting two of the phase outputs to one phase and the other one to another phase
Inverter-based system (100), which includes at least 3 phases and at least one neutral connection point, makes single-phase operation by connecting all three phase outputs to the same phase
The control unit takes the current and voltage measurements and converts them to the digital, and generates PWM by making the necessary calculations
The controller unit reduces the need for filtering necessary at the output by using interleaved carrier signals.

7. An inverter based system (100), characterized by a controller structure which detects that the product is connected to three phases, two phases or single phase and accordingly controls each phase output independently.

8. An inverter-based system (100), which clears the current harmonics drawn from a single phase, two phases or three phases, compensates for the reactive power, can keep the power factor of the facility at the desired level and perform the load balancing, characterized in that it can perform said functions separately or simultaneously.
